(19) United States
(12) Patent Application Publication
(10) Pub. No.: US 2026/0050861 A1
(43) Pub. Date: Feb. 19, 2026

(54) Social Engineering Threat Assessment Platform (SETAP)

(71) Applicant: Bank of America Corporation, Charlotte, NC (US)

(72) Inventors: Charles Philip, Andheri (IN); Vaibhav Bansal, Delhi (IN)

(21) Appl. No.: 18/806,181

(22) Filed: Aug. 15, 2024

(51) Int. Cl. G06Q 10/0639; G06Q 10/0631; H04L 9/40

(52) U.S. Cl. CPC G06Q 10/06398; G06Q 10/063112; H04L 63/1483

(57) ABSTRACT

The present disclosure provides a method, a computing platform, and a system for social engineering threat assessment. The method, conducted by a computing platform having one or more processors, includes converting social engineering threat data into one or more templates, simulating one or more social engineering attacks for a target based on the one or more templates, analyzing the one or more simulated social engineering attacks for the target; executing the one or more simulated social engineering attacks for the target based on analysis results by initiating one or more simulated vishing phone calls to the target, receiving, from a computing device associated with the target, response data responsive to the one or more simulated vishing phone calls, and providing, as feedback, execution results to one or more parties.

### TECHNICAL FIELD

Generally, the present disclosure relates to an assessment method, a computing platform, and a system. More particularly, the present disclosure relates to social engineering threat assessment.

### BACKGROUND

Cyber-attacks can take various forms, such as forms of emails, text messages, and phone calls. Unauthorized users initiating cyber-attacks are getting more sophisticated in targeting individuals for personal or business sensitive information. For example, threat actors use deepfake phone calls to ask for sensitive information from unsuspecting users, which can result in compromised personal information for the user. In another example, threat actors may combine vishing calls with smishing text messages and/or phishing emails to illegally acquire sensitive information from users. Victims of cyber-attacks often suffer financial loss and/or business disruption. To combat cyber-attacks, technologies and awareness trainings play critical roles. Currently, technologies such as threat intelligence and anti-spam software, have been constantly developed in order to address and mitigate damage from cyber-attacks. However, conventional threat awareness arrangements do not train potentially targeted individuals on how to differentiate between a vishing and a non-vishing call. Further, conventional arrangements may make it difficult to identify and report smishing text messages or phishing emails that are sent by threat actors.

Examples described herein provide a social engineering threat assessment platform capable of launching trainings to potentially targeted individuals, identifying areas where specific improvements are required, and reporting training results to relevant parties.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some examples, the present disclosure may provide a method for assessing social engineering attacks. The method may include converting social engineering threat data into one or more templates, simulating one or more social engineering attacks for a target based on the one or more templates, analyzing the one or more simulated social engineering attacks for the target, executing the one or more simulated social engineering attacks for the target based on analysis results by initiating one or more simulated vishing phone calls to the target, receiving, from a computing device associated with the target, response data responsive to the one or more simulated vishing phone calls: responsive to the response data including the target answering the one or more simulated vishing phone calls, triggering at least one of: one or more simulated smishing text messages or one or more simulated phishing emails to be sent to the computing device associated with the target; responsive to the response data including the target rejecting the one or more simulated vishing phone calls, triggering one or more simulated smishing text messages to be sent to the computing device associated with the target; responsive to the response data including the target not answering the one or more simulated vishing phone calls, recording an incident and rescheduling the one or more simulated vishing phone calls, and providing, as feedback, execution results to one or more parties.

In some examples, the social engineering threat data may include data that is obtained and consolidated from at least one of one or more external third-party vendors or an organization associated with the target.

In some examples, the data of the organization may include at least one of a position that the target holds, responsibilities that the target has, a group that the target belongs to, or a hierarchy that the target is located within the organization.

In some examples, the method may include scheduling a time to execute the one or more simulated social engineering attacks for the target.

In some examples, the method may include analyzing at least one of applicability of the one or more simulated social engineering attacks, completeness of the one or more simulated social engineering attacks, or timing for which the one or more simulated social engineering attacks is scheduled to execute.

In some examples, the method may include providing, as feedback, the execution results to an organization that the target belongs to, or providing, as feedback, the execution results for an analysis of another one or more simulated social engineering attacks for targets within the organization.

In some examples, the providing, as feedback, the execution results to the organization that the target belongs to may cause a computing device associated with the organization to execute one or more mitigating actions based on the execution results.

In some examples, the present disclosure may provide a computing platform. The computing platform may include at least one processor, a communication interface communicatively coupled to the at least one processor, and memory storing computer-readable instructions that, when executed by the at least one processor, cause the computing platform to convert social engineering threat data into one or more templates, simulate one or more social engineering attacks for a target based on the one or more templates, analyze the one or more simulated social engineering attacks for the target, execute the one or more simulated social engineering attacks for the target based on analysis results by initiating one or more simulated vishing phone calls to the target, receive, from a computing device associated with the target, response data responsive to the one or more simulated vishing phone calls: responsive to the response data including the target answering the one or more simulated vishing phone calls, triggering at least one of: one or more simulated smishing text messages or one or more simulated phishing emails to be sent to the computing device associated with the target; responsive to the response data including the target rejecting the one or more simulated vishing phone calls, triggering one or more simulated smishing text messages to be sent to the computing device associated with the target; responsive to the response data including the target not answering the one or more simulated vishing phone calls, recording an incident and rescheduling the one or more simulated vishing phone calls, and provide, as feedback, execution results to one or more parties.

In some examples, the present disclosure may provide a non-transitory computer-readable medium, having computer-executable instructions stored thereon, the computer-executable instructions, when executed by one or more processors of a computing platform, cause the computing platform to facilitate converting social engineering threat data into one or more templates, simulating one or more social engineering attacks for a target based on the one or more templates, analyzing the one or more simulated social engineering attacks for the target, executing the one or more simulated social engineering attacks for the target based on analysis results by initiating one or more simulated vishing phone calls to the target, receiving, from a computing device associated with the target, response data responsive to the one or more simulated vishing phone calls: responsive to the response data including the target answering the one or more simulated vishing phone calls, triggering at least one of: one or more simulated smishing text messages or one or more simulated phishing emails to be sent to the computing device associated with the target; responsive to the response data including the target rejecting the one or more simulated vishing phone calls, triggering one or more simulated smishing text messages to be sent to the computing device associated with the target; responsive to the response data including the target not answering the one or more simulated vishing phone calls, recording an incident and rescheduling the one or more simulated vishing phone calls, and providing, as feedback, execution results to one or more parties.

### BRIEF DESCRIPTION OF THE DRAWINGS

The present disclosure is illustrated by way of example and not limited in the accompanying figures in which like reference numerals indicate similar elements and in which:

FIG. 1 illustrates an example of an overview of various forms of social engineering attacks according to some examples of the present disclosure;

FIG. 2 illustrates a schematic diagram of a social engineering threat assessment platform (SETAP) according to some examples of the present disclosure;

FIG. 3 illustrates a schematic diagram of scenarios encountered during a cyber security training conducted by a SETAP according to some examples of the present disclosure;

FIG. 4 illustrates a schematic flowchart of a method for assessing social engineering threats according to some examples of the present disclosure;

FIG. 5 illustrates a schematic diagram of a SETAP with one detailed feedback loop according to some examples of the present disclosure;

FIG. 6 illustrates a schematic diagram of a SETAP with another detailed feedback loop according to some examples of the present disclosure;

FIG. 7 illustrates a schematic diagram of a SETAP with another detailed feedback loop according to some examples of the present disclosure;

FIG. 8 illustrates a schematic diagram of a SETAP with another detailed feedback loop according to some examples of the present disclosure; and

FIG. 9 illustrates a schematic diagram of a computing platform for assessing social engineering threats according to some examples of the present disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The present disclosure provides a social engineering threat assessment platform (SETAP), which trains people's awareness with respect to social engineering attacks so as to stay vigilant against such attacks. In general, social engineering attacks may include communications with users (e.g., via call, text, email, or the like) that attempt to manipulate users into making security mistakes and/or giving away sensitive information. The SETAP may leverage third party intelligence data sources and then consolidate these data sources. The SETAP may also utilize respective data related to particular individuals within an organization. Based on the data sources/data, the SETAP may simulate social engineering attacks that may potentially happen in real life and compromise the organization's business or operation. With the simulated social engineering attacks, the SETAP may conduct trainings to these particular individuals to enhance their awareness of potential social engineering attacks in day-to-day business or operation. The SETAP may then feedback training results to improve its simulation of social engineering attacks. The SETAP may further feedback the training results to different parties within the organization to execute mitigating actions.

Some examples described herein relate to a system for assessing social engineering threats. Similar to social engineering attacks, social engineering threats may use human emotion, for example, fear and urgency, to trick people into disclosing sensitive data, sharing credentials, and/or granting access to a personal computing device through communications generated by threat actors. The system may include one or more data sources related to cyber threat intelligence and also related to particularly targeted individuals. The system may generate social engineering attacks based on the one or more data sources. The system may then analyze the generated social engineering attacks for training the particularly targeted individuals. The system may also provide training results to one or more stakeholders within the system. With corresponding actions taken by the one or more stakeholders, the particularly targeted individuals may obtain adequate trainings tailored to each individual's situation in a timely manner.

Some examples described herein relate to a computing platform within a system that assesses social engineering threats. One or more processors of the computing platform may be configured to generate simulated social engineering attacks based on one or more data sources. The one or more processors may be configured to train targeted individuals within an organization by applying or executing the simulated social engineering attacks. The one or more processors may be configured to loop back training results to analyze simulated social engineering attacks for further trainings. The one or more processors may be configured to provide the training results to various parties of the organization for future actions.

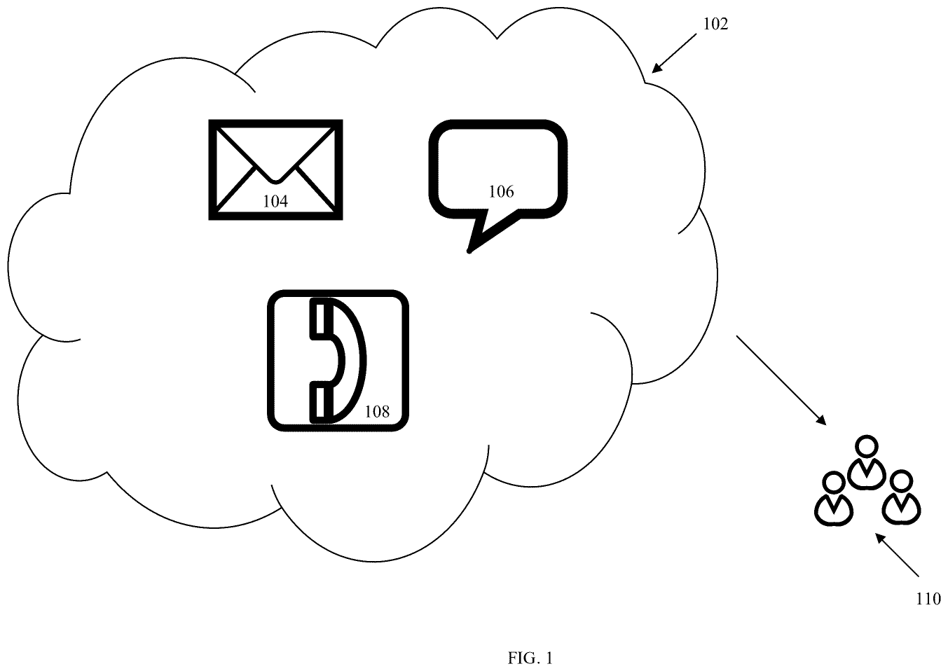

FIG. 1 illustrates an example of an overview of various forms of social engineering attacks according to some examples of the present disclosure.

In general, social engineering attacks 102 may make use of human elements through human interactions to gain unauthorized access to data or network. Unauthorized users or threat actors may manipulate a targeted individual or take advantage of the targeted individual to trick them into leaking sensitive information. Consequently, social engineering attacks may cause financial loss and/or business interruption.

Individuals and employees within organizations 110 may face multiple social engineering attacks that take various forms. For example, social engineering attacks may be in forms of phone calls, text messages, and emails. Fraudulent phone calls 108, also known as vishing phone calls, may generally induce a target to reveal personal information. Fraudulent text messages 106, also known as smishing text messages, may generally trick a target into revealing sensitive data. Fraudulent emails 104, also known as phishing emails, may generally hook a target in order to steal sensitive data from their personal or work computers.

Technology development may be a focus in order to tackle issues of social engineering attacks 102. However, awareness training may also play an equally critical role in tackling the issues. Some examples of the present disclosure provide a mechanism that may integrate available intelligence data and simulate social engineering attacks based on this intelligence data for training individuals. Through the trainings, individuals learn how to identifying cyber threats of this nature and protect themselves from social engineering attacks so that unnecessary loss or disruption may be mitigated or even avoided.

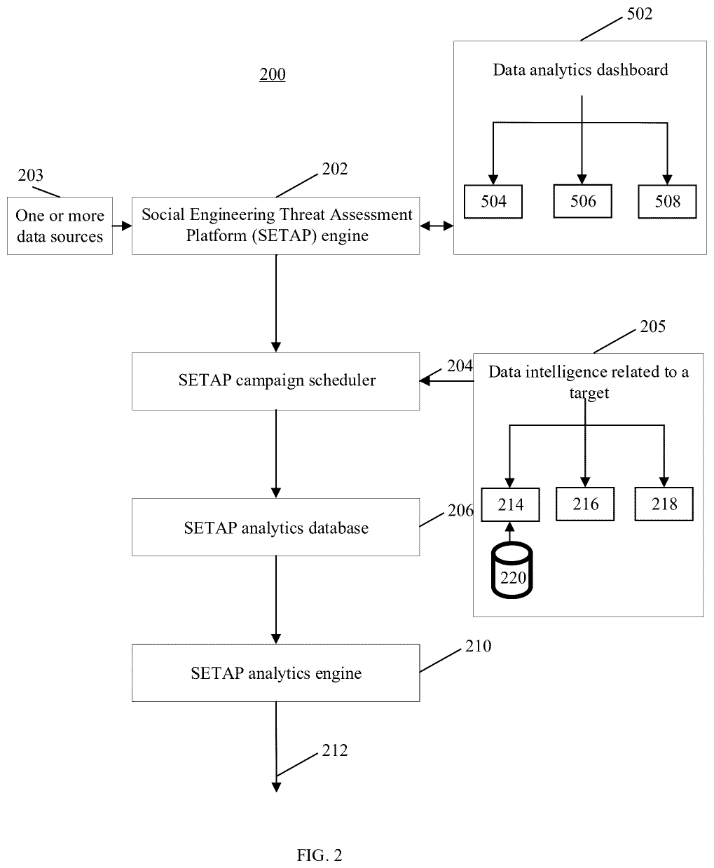

FIG. 2 illustrates a schematic diagram of a social engineering threat assessment platform (SETAP) according to some examples of the present disclosure.

In some examples, a SETAP 200 may include a SETAP engine 202, which may receive intelligence data 203 related to cyber security that may be most recently developed and available on the market. The intelligence data 203 may be received from various sources. For example, the intelligence data 203 may be obtained from open source intelligence (OSINT) sources. The intelligence data 203 may be obtained from external third-party vendor's intelligence. The intelligence data 203 may be obtained from any other kinds of cyber threat intelligence. Additionally and/or alternatively, the intelligence data 203 may be obtained from other different sources. The SETAP engine 202 may consolidate the intelligence data 203 from different sources. The SETAP engine 202 may modify the intelligence data 203 to its individual needs. The SETAP engine 202 may also convert the intelligence data 203 according to templates used by the SETAP 200. For example, the intelligence data 203 that is available in public or on the market may be general, the SETAP engine 202 may modify the intelligence data 203 according to a targeted individual or a targeted organization. For example, the SETAP engine 202 may take advantage of all available data by converting the intelligence data 203 into its templates and storing the data locally.

The SETAP engine 202 may further utilize a publicly available data analytics dashboard 502 to create specific data related to a specific target within an organization over a specific timeframe. For example, the data analytics dashboard 502 may trigger different responsible groups within the organization to provide such data. The organization may be an organization in a financial services industry, a pharmaceutical industry, manufacturing industry, government entity, university or other academic setting, or the like. Additionally and/or alternatively, the organization may be an organization in other types of industries.

The different responsible groups within the organization may include a risk assessment team 504, which may define risks that are particularly applicable to the organization. The different responsible groups within the organization may include a global information security (GIS) team 506, which may scan and look for any threat actors or threat actions, for example, according to its data library. The GIS team 506 may also use its data library to record information of any newly discovered threat actors and threat actions for future use. The different responsible groups within the organization may include a line of business (LOB) executive 508, which may report certain actions that likely compromise the organization's security. Additionally and/or alternatively, the different responsible groups within the organization may also include other groups responsible for cyber security.

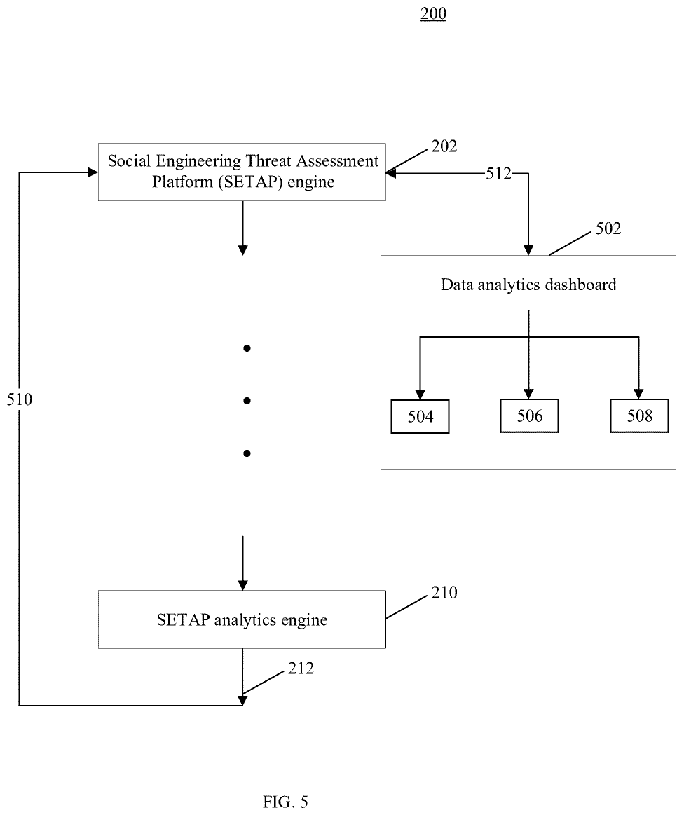

As will be described below with reference to FIG. 5, while the data analytics dashboard 502 may provide data of the specific target to the SETAP engine 202, the SETAP engine 202 may also provide training results conducted on the specific target to the data analytics dashboard 502 for further data analysis and data refinement.

In some examples, the SETAP engine 202 may then convert the collected data, for example, the intelligence data 203 and data from the data analytics dashboard 502, into templates for training individuals within the organization. These templates may be used to create simulated vishing phone calls 108, smishing text messages 106, and phishing emails 104, as shown in FIG. 1, to be sent to the individuals during the trainings. Additionally and/or alternatively, these templates may be used to create simulated social engineering attacks in other types of forms.

In some examples, a SETAP 200 may include a SETAP campaign scheduler 204. In general, all employees of the organization may be scheduled for cyber security trainings. However, trainings conducted on each employee may be tailored based on each individual's unique situation. As shown in FIG. 2, the SETAP campaign scheduler 204 may receive an input 205 regarding data intelligence related to respective employees. For example, the data intelligence input 205 may be provided by the organization.

The data intelligence input 205 may include employee information 214 within the organization. The employee information 214 may be obtained through a database 220 of the organization. The employee information 214 may include a position that a particular employee holds, a team or a group that a particular employee belongs to, and a particular employee's hierarchy within a team or a group. Additionally and/or alternatively, the employee information 214 may include other specifics about a particular employee.

For example, in a financial services industry, an employee's position in a finance department or in an investment banking department may include access to critical or sensitive information that other employees might not access. Potential social engineering attacks on these particular example employees may compromise the assets that are managed by the organization.

The data intelligence input 205 may include line of business (LOB) information 216 of the organization. The LOB information 216 may provide intelligence as to how to recognize an employee's communications, including emails or other types of communications. For example, the LOB information 216 may identify a particular behavioral pattern of a particular employee during business or operation of the organization.

The data intelligence input 205 may include cyber threat intelligence (CTI) scripts 218. In general, the CTI scripts 218 may store or include scripts that have been used for training employees of the organization. For example, with these stored scripts, whether a newly created training covers all aspects of a potential social engineering attack may be verified. Accordingly, amendments may be made to the newly created training. These amendments may be made by the SETAP campaign scheduler 204. Additionally and/or alternatively, these amendments may be made manually.

The SETAP campaign scheduler 204 may then simulate social engineering attacks for cyber security trainings based on the data intelligence 205, and also, based on templates converted by the SETAP engine 202 from the data 203 and data provided by the data analytics dashboard 502. The SETAP campaign scheduler 204 may also schedule a simulated social engineering attack specific to an employee for a specific point of time. As such, simulated social engineering attacks may run with minimal human involvement. Additionally and/or alternatively, simulated social engineering attacks may be scheduled manually based on the employee's role within the organization or the organization's needs.

In some examples, a SETAP 200 may include a SETAP analytics database 206. The SETAP analytics database 206 may analyze the simulated social engineering attacks before they are executed to train targeted employees as scheduled. For example, the SETAP analytics database 206 may analyze whether areas specifically applicable to a particularly targeted employee have been included in a simulated social engineering attack generated by the SETAP campaign scheduler 204. For example, the SETAP analytics database 206 may analyze whether any important aspects of a cyber security training are missing in a simulated social engineering attack. For example, the SETAP analytics database 206 may analyze whether a simulated social engineering attack appears to be genuine enough to bait a particular targeted employec. Additionally and/or alternatively, the SETAP analytics database 206 may analyze other elements in a simulated social engineering attack based on historic data.

In some examples, the SETAP analytics database 206 may utilize structured query language (SQL) to query databases regarding specifics of a targeted employee within the organization. Accordingly, a simulated social engineering attack to be conducted on that targeted employee may be more specific to their individual situations. Additionally and/or alternatively, the SETAP analytics database 206 may utilize other types of computing languages to describe specifics of employees.

In some examples, a SETAP 200 may include a SETAP analytics engine 210. After each training, for example, after the simulated social engineering attacks are conducted on respective employees, corresponding training results may be fed into the SETAP analytics engine 210. Accordingly, the SETAP analytics engine 210 may run analysis on the training results, which may include, for example, specifics of respective employees, their performance in various areas, and their behavioral patterns during business or operation. Additionally and/or alternatively, analysis on the training results may include other types of information. The SETAP analytics engine 210 may then feedback the analyzed training results 212 to various parties.

In some examples, the SETAP analytics engine 210 may feedback the analyzed training results 212 to the SETAP engine 202, as shown in FIG. 5.

The SETAP engine 202 may further forward the analyzed training results 212 to the data analytics dashboard 502, as shown in FIG. 2 and FIG. 5 as well.

The data analytics dashboard 502 may make corresponding graphs regarding performance of the employees who have taken the cyber security training. The data analytics dashboard 502 may further present these corresponding graphs to the organization. For example, these corresponding graphs may be presented to the risk assessment team 504, the GIS team 506, and the LOB executive 508 for further data processing. The processed data may be provided back to the SETAP engine 202 to be converted into updated cyber security training templates for future use.

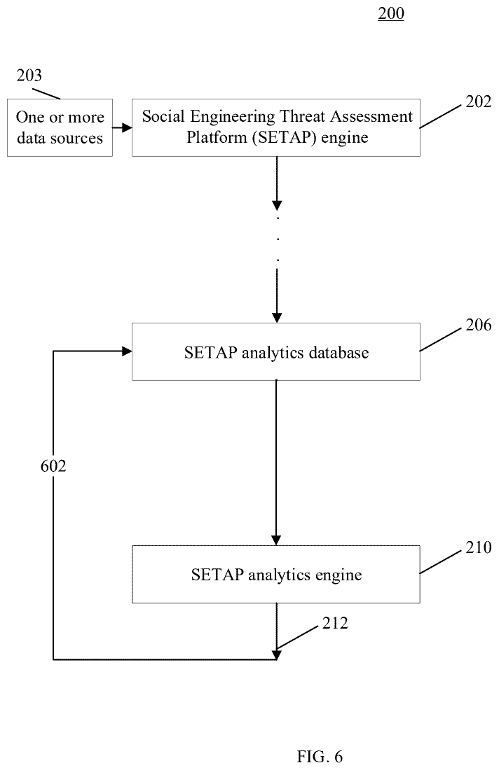

In some examples, the SETAP analytics engine 210 may feedback the analyzed training results 212 to the SETAP analytics database 206, as shown in FIG. 6.

The SETAP analytics database 206 may run its own analysis on the analyzed training results 212, which may be used to improve analysis of further simulated social engineering attacks. The SETAP analytics database 206 may also store the relevant information locally in its database for such improvement.

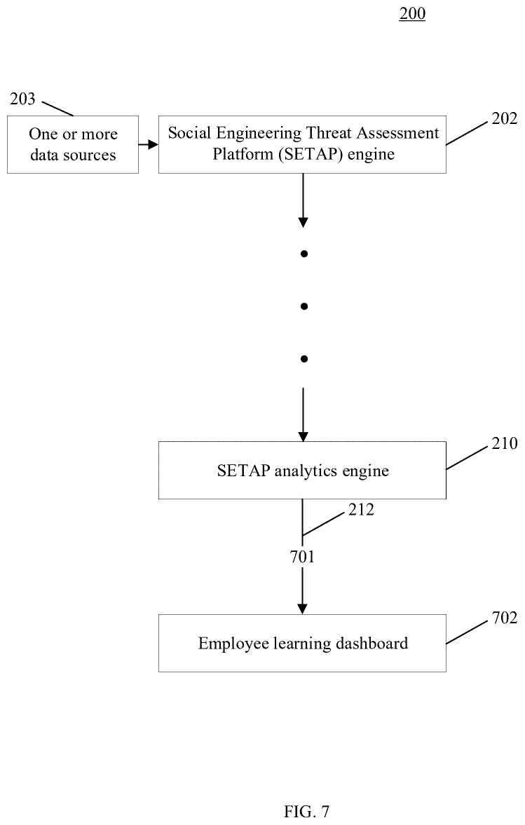

In some examples, the SETAP analytics engine 210 may feedback the analyzed training results 212 to an employee learning board 702, as shown in FIG. 7.

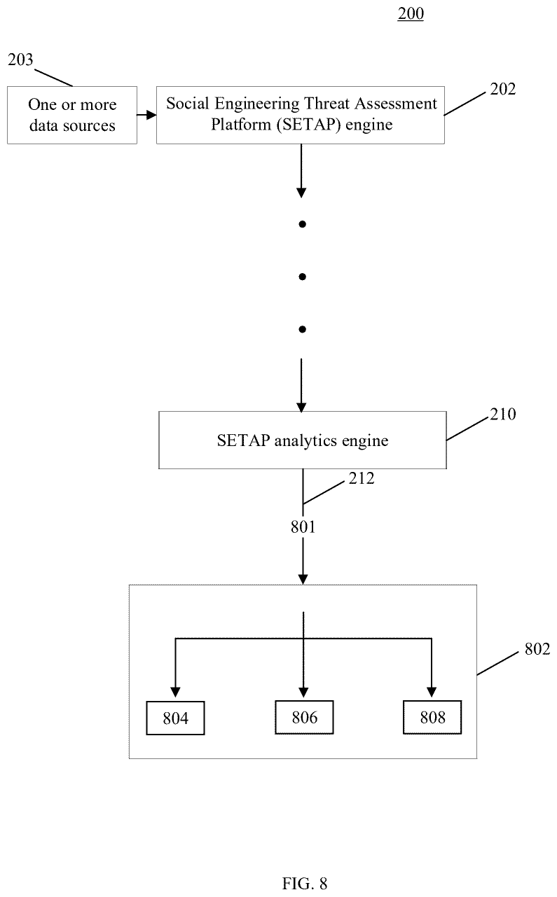

In some examples, the SETAP analytics engine 210 may feedback the analyzed training results 212 to one or more responsible groups 802 with the organization, as shown in FIG. 8. For example, the one or more responsible groups 802 may include a security operation center (SOC) team 804, an access operation team 806, and a data leakage prevention (DLP) team 808. Additionally and/or alternatively, the one or more responsible groups 802 may include other teams of the organization.

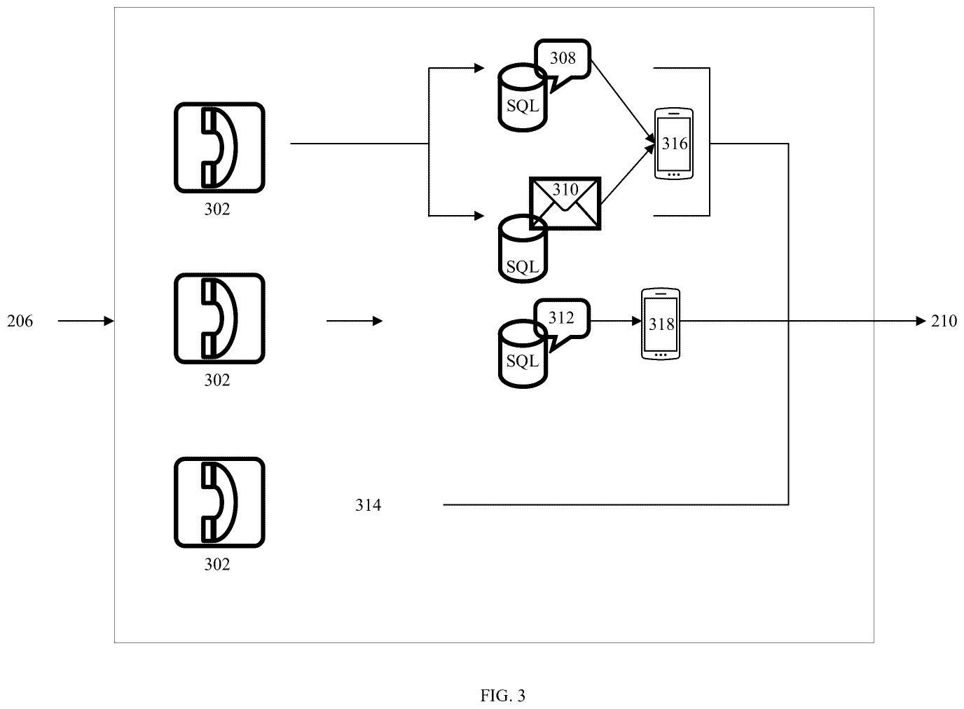

FIG. 3 illustrates a schematic diagram of scenarios encountered during a cyber security training conducted by a SETAP according to some examples of the present disclosure.

After the SETAP analytics database 206 analyzes the simulated social engineering attacks and confirms their completeness and/or applicability, the simulated social engineering attacks may be conducted on respective employees as scheduled by the SETAP campaign scheduler 204. Each of the simulated social engineering attacks may start with a simulated vishing phone call to a targeted employee executed by the SETAP 200. A simulated vishing phone call may be an unsolicited phone call, or may be a phone call that appears to be from a manager of the target employee by using deepfake technology. A simulated vishing phone call may sound urgent or alarming so that the targeted employee may be tricked to reveal sensitive information to the caller or take a step further in revealing more information to the caller.

In general, it may be unlikely that anybody, including the targeted employee, would reveal any sensitive information to an unknown caller through an unsolicited phone call. Accordingly, the simulated social engineering attacks generated by the SETAP 200 may include other forms of cyber-attacks in order to further trick the targeted employee so as to achieve a training goal. The other forms of cyber-attacks may include smishing text messages and/or phishing emails.

In some examples, if the targeted employee receives a simulated vishing phone call 302 and answers it, a simulated smishing text message 308 may be triggered and sent, by the SETAP 200, to their computing device 316 (e.g., smart device, mobile phone, wearable device, or the like). The simulated smishing text message 308 may seem like it is from a legitimate organization, for example, from a financial institution or from an employer of the user. The simulated smishing text message 308 may include a link or a phone number that baits the targeted employee into clicking or calling. If the targeted employee does so, there may be a good chance that their personal information may be manipulated. The simulated smishing text message 308 may include a link that entices the targeted employee to download malware to their computing device 316. The simulated smishing text message 308 may be generated based on databases and/or scripts written in SQL. Additionally and/or alternatively, the simulated smishing text message 308 may be generated based on databases and/or scripts written in other computing languages.

In some examples, if the targeted employee receives a simulated vishing phone call 302 and answers it, a simulated phishing email 310, may be triggered and sent, by the SETAP 200, to the targeted employee's computing device 316. The simulated phishing email 310 may include a link or an attachment. Once the targeted employee clicks the link or opens the attachment, they may be asked to enter their sensitive information, such as passwords, account numbers, social security numbers, tokens, and other types of credentials. If the targeted employee does so, the sensitive information may be stolen and unauthorized users may get access to their email, bank, or other accounts in a real-life case. The simulated phishing email 310 may be generated based on databases and/or scripts written in SQL. Additionally and/or alternatively, the simulated phishing email 310 may be generated based on databases and/or scripts written in other computing languages.

In some examples, if the targeted employee receives a simulated vishing phone call 302 and rejects it, the targeted employee may have been aware that there may be a cyber-attack. However, the training might not stop here. In such a case, a simulated smishing text message 312 may be triggered and sent, by the SETAP 200, to the targeted employee's computing device 318. Similar to the simulated smishing text message 308, the simulated smishing text message 312 may include a link or a phone number in order to trick the targeted employee to reveal sensitive information. The simulated smishing text message 312 may be generated based on databases and/or scripts written in SQL. Additionally and/or alternatively, the simulated smishing text message 312 may be generated based on databases and/or scripts written in other computing languages.

In some examples, if the targeted employee receives a simulated vishing phone call 302 and simply does nothing (e.g., allows the call to go unanswered or go to voicemail), this piece of status information 314 may be recorded. For example, the targeted employee may be busy with their work, attending a meeting, or speaking on another phone call when the training is launched. In such a case, the training may be rescheduled to be conducted on the targeted employee for another time.

The results of different scenarios happening during trainings, for example, results from the smishing text messages 308 and 312, and results from the phishing email 310, including the status information 314, may be inputted into the SETAP analytics engine 210. Accordingly, the SETAP analytics engine 210 may run analysis of these results and then feedback the analyzed results to various parties of the organization, and to various functions of the SETAP 200 as well.

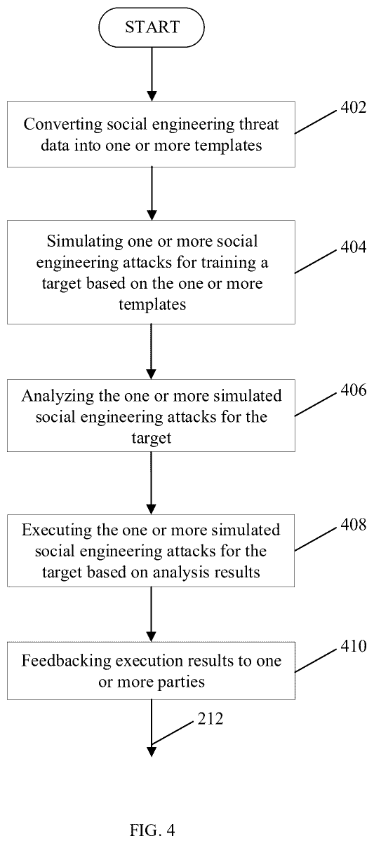

FIG. 4 illustrates a schematic flowchart of a method for assessing social engineering threats according to some examples of the present disclosure.

At step 402, a computing platform, for example, the SETAP 200 as shown in FIG. 2, may convert social engineering threat data into one or more templates.

In some examples, the social engineering threat data may include one or more data sources that are most recently upgraded and available on the market. An organization may collaborate with vendors of the one or more data sources to make use of the data for training their employees on cyber security. The SETAP 200 may consolidate the one or more data sources before using the data.

In some examples, the social engineering threat data may include data intelligence related to employees within the organization. The organization may have multiple groups tasked with different responsibilities for maintaining, analyzing, and developing such data intelligence related to employees.

At step 404, the SETAP 200 may simulate social engineering attacks for training a target based on the one or more templates.

The simulated social engineering attacks may take various forms. For example, the simulated social engineering attacks may be simulated vishing phone calls, simulated smishing text messages, and simulated phishing emails. Depending on how the target reacts to the simulated social engineering attacks, the simulated vishing phone calls, simulated smishing text messages, or simulated phishing emails may be triggered and sent to the target's computing device during a cyber security training.

Since the target for the cyber security training is identified, the social engineering attacks may be simulated based on information and/or templates specifically related to that target. As such, any particular areas where the target has not performed well, or any particular behavioral patterns that the target has exhibited may be covered during the cyber security training.

In some examples, the simulated social engineering attacks may be scheduled for a particular time to be conducted on the target so that the cyber security training may run without requiring manual instructions.

In some examples, the simulated social engineering attacks may be scheduled manually in order to prioritize a specific cyber security training to a specific employee based on their specific responsibility within the organization or the organization's needs.

At step 406, the SETAP 200 may analyze the simulated social engineering attacks for the target.

The SETAP 200 may utilize a computing language, for example, SQL, to query databases regarding the target, and then, analyze the simulated social engineering attacks as to whether they cover all aspects applicable to the target. This analysis may run based on existing templates that have been used in the past. This analysis may run based on historic training data related to the target or the groups the target belongs to. This analysis may run based on specifics of the target, for example, what information the target has access to. Additionally and/or alternatively, this analysis may also run based on other types of information.

At step 408, the SETAP 200 may execute the simulated social engineering attacks for the target based on analysis results.

If the analysis results meet criteria, it may indicate that the simulated social engineering attacks contain all desired content for the target. Accordingly, the cyber security training may start by using the simulated social engineering attacks as initially scheduled by the SETAP 200. The criteria may be preset by the organization, or the criteria may be dynamically changed according to the organization's up-to-date needs.

If the analysis results do not meet the criteria, it may indicate that the simulated social engineering attacks need to be amended, for example, additional content may be added or the current content may be edited. In such a case, the cyber security training may not start as initially scheduled by the SETAP 200 until amendments to the simulated social engineering attacks are finalized.

At step 410, the SETAP 200 may feedback training results to one or more parties.

After the cyber security training has been conducted on the target, the SETAP 200 may first analyze the training results. For example, the analysis may include a summary of how well or how badly the target has performed during the cyber security training. For example, the analysis may include a summary of in which areas the target has performed well or badly. For example, the analysis may include information as to whether there is a change of behavioral pattern exhibited by the target. Additionally and/or alternatively, the analysis may include other types of information.

The SETAP 200 may then output the analyzed training results 212 to one or more parties, which may include parties within the organization and functions of the SETAP 200 as well. For example, the analyzed training results 212 may be outputted to an employee learning board 702 of the organization, as shown in FIG. 7. For example, the analyzed training results 212 may be outputted to a SOC team 804, an access operation team 806, and a DLP team 808 of the organization, as shown in FIG. 8.

For example, the analyzed training results 212 may be outputted to a SETAP analytics database 206, as shown in FIG. 6 so that analysis of further simulated social engineering attacks may be improved. For example, the analyzed training results 212 may be outputted to a SETAP engine 202 and further forwarded to a data analytics dashboard 502, as shown in FIG. 2 and FIG. 5. The data analytics dashboard 502 may facilitate a risk assessment team 504, a GIS team 506, and a LOB executive 508 of the organization to further process the received analyzed training results 212.

FIG. 5 illustrates a schematic diagram of a SETAP with one detailed feedback loop according to some examples of the present disclosure.

In some examples, one feedback loop provided by the SETAP 200 may be a loop from the SETAP analytics engine 210 to the SETAP engine 202. The SETAP analytics engine 210 may collect results of a cyber security training conducted on a target, and then, analyze the training results. The SETAP analytics engine 210 may provide the analyzed training results 212 to the SETAP engine 202 through a feedback loop 510. The SETAP engine 202 may forward the analyzed training results 212 to the data analytics dashboard 502 through a feedback loop 512.

The data analytics dashboard 502 may then trigger responsible groups within the organization, for example, the risk assessment team 504, the GIS team 506, and the LOB executive 508, to process the analyzed training results 212. Accordingly, these responsible groups may obtain up-to-date information regarding behavioral patterns of a target that has just gone through the training. This up-to-date information may be fed back to the SETAP engine 202 as intelligence data for the SETAP engine 202 to convert it into templates. As such, further trainings created based on these templates may be more complete.

For example, the risk assessment team 504 may assess employees based on the analyzed training results 212 especially as to employees who did not have an expected or acceptable response regarding potential cyber security attacks. For example, a computing system or a computing device within the GIS team 506 (e.g., based on an instruction or command generated by the SETAP 200) may modify access permissions associated with systems, applications, databases, or the like, to block an employee's access to a database or other systems or information if data is phished through that employee. As such, potential leakage of sensitive data may be prevented. For example, a computing system or a computing device within the LOB executive 508 (e.g., based on an instruction or command generated by the SETAP 200) may report and remove credentials of an employee who did not perform well in the cyber security training. As such, these credentials might not be stolen by potential unauthorized users or threat actors. Accordingly, such an employee may not be a threat to the organization.

FIG. 6 illustrates a schematic diagram of a SETAP with another detailed feedback loop according to some examples of the present disclosure.

In some examples, one feedback loop provided by the SETAP 200 may be a loop from the SETAP analytics engine 210 to the SETAP analytics database 206. The SETAP analytics engine 210 may provide the analyzed training results 212 to the SETAP analytics database 206 through a feedback loop 602. The SETAP analytics database 206 may utilize the analyzed training results 212 to refine its analysis on simulated social engineering attacks. Accordingly, further simulated social engineering attacks may be completer and more specific to a targeted individual.

FIG. 7 illustrates a schematic diagram of a SETAP with another detailed feedback loop according to some examples of the present disclosure.

In some examples, one feedback loop provided by the SETAP 200 may be a loop from the SETAP analytics engine 210 to the employee learning dashboard 702. The SETAP analytics engine 210 may provide the analyzed training results 212 to the employee learning dashboard 702 through a feedback loop 701. The employee learning dashboard 702 may further provide the analyzed training results 212 to respective employees who have taken the cyber security training. The employee learning dashboard 702 may also provide actions that need to be taken for some of the employees. For example, an employee may be assigned to take another cyber security training in the areas where they did not perform well last time. The other cyber security training may be generated, scheduled, conducted, and feedbacked similarly as described with reference to FIG. 4. The employee may be assessed again after taking the other cyber security training as to whether they are sufficiently aware of potential cyber-attacks or not. For example, an employee, who did not answer the vishing phone call 302 shown in FIG. 3, meaning that they did not take the cyber security training at all last time, may be assigned to take an exact same cyber security training. As such, no one is left out for the cyber security trainings. Additionally and/or alternatively, the employee learning dashboard 702 may provide other types of information to the employees.

FIG. 8 illustrates a schematic diagram of a SETAP with another detailed feedback loop according to some examples of the present disclosure.

In some examples, one feedback loop provided by the SETAP 200 may be a loop from the SETAP analytics engine 210 to one or more responsible groups 802 within the organization. The SETAP analytics engine 210 may provide the analyzed training results 212 to the one or more responsible groups 802 through a feedback loop 801. The one or more responsible groups 802 may include a SOC team 804, an access operation team 806, and a DLP team 808. Additionally and/or alternatively, the one or more responsible groups 802 may include other teams within the organization.

The one or more responsible groups 802 within the organization may take necessary actions based on the analyzed training results 212. For example, for the areas where average employees did not perform well, the one or more responsible groups 802 may look into that and place more robust measures for potential data leakage. For example, if a particular employee did not perform well in certain sensitive areas, or if a particular employee generally did not perform well in a cyber security training, for example, three times in a row, the one or more responsible groups 802 may block any accesses granted to that particular employee. This employee may be granted an access again after they pass a tailored training applicable to their situation at a later point in time. In general, assignment of a cyber security training to an employee and/or assessment of an employee's performance in a cyber security training may be customized based on each employee's individual situation and/or an organization's needs.

In some examples, the SOC team 804 may identify which employees have leaked critical information of the organization based on the analyzed training results 212. The SOC team 804 may isolate such employees and treat them separately for security purposes. In a scenario where an employee works for an investment banking department of a financial institution, this identification may be important, as leakage may cause significant loss to the bank. The access operation team 806 may identify what accesses that employee has. For those employees who did not perform well during the cyber security training, they may only be granted limited access or limited privileges to certain databases of the organization. The DLP team 808 may further treat those employees as threats to the organization and monitor their activities during business or operation, such as their correspondences through phone calls and emails.

Additionally and/or alternatively, other actions may be taken based on the analyzed training results 212 to prevent potential loss of the organization.

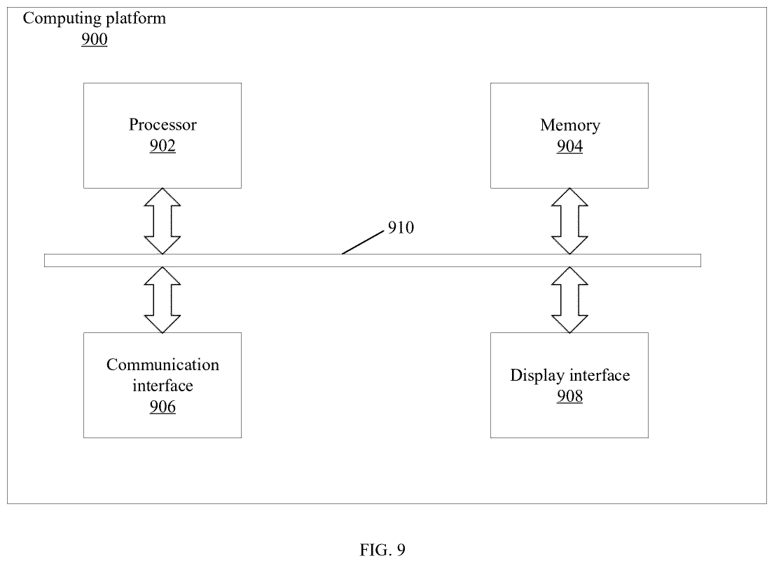

FIG. 9 illustrates a schematic diagram of a computing platform for assessing social engineering threats according to some examples of the present disclosure.

The computing platform 900 may include a processor 902, memory 904, and a communication interface 906. The computing platform 900 may include a bus 910, through which the processor 902, the memory 904, the communication interface 906, and other components of the computing platform 900 exchange information with each other.

The computing platform 900 may include a display interface 908. For example, the display interface 908 may display training campaigns scheduled for respective employees within the organization as shown at step 404 of FIG. 4. For example, the display interface 908 may display analyzed training results 212 as shown at step 410 of FIG. 4. Additionally and/or alternatively, the display interface 908 may show other types of information. Additionally and/or alternatively, the display interface 908 may be independent from the computing platform 900 (e.g., part of a user computing device).

The processor 902 may include one or more general-purpose processors, such as a central processing unit (CPU), or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

The memory 904 may include volatile memory, for example, random-access memory (RAM). The memory 904 may further include non-volatile memory (NVM), for example, read-only memory (ROM), flash memory, hard disk drive (HDD), or solid-state drive (SSD). The memory 904 may further include a combination of the foregoing types.

The memory 904 may have computer-readable program codes stored thereon. The processor 902 may read the computer-readable program codes stored on the memory 904 to perform the method described according to FIG. 4 for assessing social engineering threats. Additionally and/or alternatively, the processor 902 may read the computer-readable program codes stored on the memory 904 to perform one or more other functions, or a combination of these functions.

The processor 902 may further communicate with another computing device through the communication interface 906. For example, the processor 902 may further communicate with external physical memory or external memory on a cloud to obtain data sources for cyber security training templates. For example, the processor 902 may communicate with an external database stored on an organization's server for employee specific data. For example, the processor 902 may communicate with one or more responsible groups of an organization to obtain employees' historical behavioral patterns and performance during any past cyber security trainings.

The processor 902 may also trigger the display interface 908 to display the information to an organization and their employees as described above. For example, the processor 902 may trigger the display interface 908 to display the analyzed training results 212 to the groups 504, 506, and 508 of the organization in a form of graphs, as shown in FIG. 2 and FIG. 5. For example, the processor 902 may trigger the display interface 908 to display the analyzed training results 212 to employees through an employee learning dashboard 702, as shown in FIG. 7. For example, the processor 902 may trigger the display interface 908 to display the analyzed training results 212 to the groups 804, 806, and 808 of the organization, as shown in FIG. 8, for them to take necessary preventive actions.

A person of ordinary skill in the art will appreciate that the computing platform 900 as shown in FIG. 9 may communicate with one or more further computing devices through the communication interface 906 or wireless connections for further functions, or a combination of functions. Further, the computing platform 900 as shown in FIG. 9 may also include one or more further functional components to perform and/or trigger further functions, or a combination of functions.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method for assessing social engineering threats, comprising:
converting, by a computing platform having one or more processors, social engineering threat data into one or more templates;
simulating, by the one or more processors, one or more social engineering attacks for a target based on the one or more templates;
analyzing, by the one or more processors, the one or more simulated social engineering attacks for the target;
executing, by the one or more processors, the one or more simulated social engineering attacks for the target based on analysis results by initiating one or more simulated vishing phone calls to the target;
receiving, from a computing device associated with the target, response data responsive to the one or more simulated vishing phone calls: responsive to the response data including the target answering the one or more simulated vishing phone calls, triggering at least one of: one or more simulated smishing text messages or one or more simulated phishing emails to be sent to the computing device associated with the target; responsive to the response data including the target rejecting the one or more simulated vishing phone calls, triggering one or more simulated smishing text messages to be sent to the computing device associated with the target; responsive to the response data including the target not answering the one or more simulated vishing phone calls, recording an incident and rescheduling the one or more simulated vishing phone calls; and
providing, as feedback by the one or more processors, execution results to one or more parties.

2. The method of claim 1, wherein the social engineering threat data comprises data that is obtained and consolidated from at least one of one or more external third-party vendors or an organization associated with the target.

3. The method of claim 2, wherein the data of the organization comprises at least one of a position that the target holds, responsibilities that the target has, a group that the target belongs to, or a hierarchy that the target is located within the organization.

4. The method of claim 1, wherein simulating, by the one or more processors, the one or more social engineering attacks for the target based on the one or more templates comprises:
scheduling, by the one or more processors, a time to execute the one or more simulated social engineering attacks for the target.

5. The method of claim 1, wherein the analyzing, by the one or more processors, the one or more simulated social engineering attacks for the target comprises:
analyzing, by the one or more processors, at least one of applicability of the one or more simulated social engineering attacks, completeness of the one or more simulated social engineering attacks, or timing for which the one or more simulated social engineering attacks is scheduled to execute.

6. The method of claim 1, wherein the providing, as feedback by the one or more processors, the execution results to the one or more parties comprises at least one of:
providing, as feedback by the one or more processors, the execution results to an organization that the target belongs to; or
providing, as feedback by the one or more processors, the execution results for an analysis of another one or more simulated social engineering attacks for targets within the organization.

7. The method of claim 6, wherein the providing, as feedback by the one or more processors, the execution results to the organization that the target belongs to causes a computing device associated with the organization to execute one or more mitigating actions based on the execution results.

8. A computing platform, comprising:
at least one processor;
a communication interface communicatively coupled to the at least one processor; and memory storing computer-readable instructions that, when executed by the at least one processor, cause the computing platform to:
convert social engineering threat data into one or more templates;
simulate one or more social engineering attacks for a target based on the one or more templates;
analyze the one or more simulated social engineering attacks for the target;
execute the one or more simulated social engineering attacks for the target based on analysis results by initiating one or more simulated vishing phone calls to the target;
receive, from a computing device associated with the target, response data responsive to the one or more simulated vishing phone calls: responsive to the response data including the target answering the one or more simulated vishing phone calls, triggering at least one of: one or more simulated smishing text messages or one or more simulated phishing emails to be sent to the computing device associated with the target; responsive to the response data including the target rejecting the one or more simulated vishing phone calls, triggering one or more simulated smishing text messages to be sent to the computing device associated with the target; responsive to the response data including the target not answering the one or more simulated vishing phone calls, recording an incident and rescheduling the one or more simulated vishing phone calls; and
provide, as feedback, execution results to one or more parties.

9. The computing platform of claim 8, wherein the social engineering threat data comprises data that is obtained and consolidated from at least one of one or more external third-party vendors or an organization associated with the target.

10. The computing platform of claim 9, wherein the data of the organization comprises at least one of a position that the target holds, responsibilities that the target has, a group that the target belongs to, or a hierarchy that the target is located within the organization.

11. The computing platform of claim 8, wherein the computer-readable instructions further cause the computing platform to:
schedule a time to execute the one or more simulated social engineering attacks for the target.

12. The computing platform of claim 8, wherein the computer-readable instructions further cause the computing platform to:
analyze at least one of applicability of the one or more simulated social engineering attacks, completeness of the one or more simulated social engineering attacks, or timing for which the one or more simulated social engineering attacks is scheduled to execute.

13. The computing platform of claim 8, wherein the computer-readable instructions further cause the computing platform to:
provide, as feedback, the execution results to an organization that the target belongs to; or
provide, as feedback, the execution results for an analysis of another one or more simulated social engineering attacks for targets within the organization.

14. The computing platform of claim 13, wherein the providing, as feedback, the execution results to the organization that the target belongs to causes a computing device associated with the organization to execute one or more mitigating actions based on the execution results.

15. A non-transitory computer-readable medium, having computer-executable instructions stored thereon, the computer-executable instructions, when executed by one or more processors of a computing platform, cause the computing platform to facilitate:
converting social engineering threat data into one or more templates;
simulating one or more social engineering attacks for a target based on the one or more templates;
analyzing the one or more simulated social engineering attacks for the target;
executing the one or more simulated social engineering attacks for the target based on analysis results by initiating one or more simulated vishing phone calls to the target;
receiving, from a computing device associated with the target, response data responsive to the one or more simulated vishing phone calls: responsive to the response data including the target answering the one or more simulated vishing phone calls, triggering at least one of: one or more simulated smishing text messages or one or more simulated phishing emails to be sent to the computing device associated with the target; responsive to the response data including the target rejecting the one or more simulated vishing phone calls, triggering one or more simulated smishing text messages to be sent to the computing device associated with the target; responsive to the response data including the target not answering the one or more simulated vishing phone calls, recording an incident and rescheduling the one or more simulated vishing phone calls; and
providing, as feedback, execution results to one or more parties.

16. The non-transitory computer-readable medium of claim 15, wherein the social engineering threat data comprises data that is obtained and consolidated from at least one of one or more external third-party vendors or an organization associated with the target.

17. The non-transitory computer-readable medium of claim 16, wherein the data of the organization comprises at least one of a position that the target holds, responsibilities that the target has, a group that the target belongs to, or a hierarchy that the target is located within the organization.

18. The non-transitory computer-readable medium of claim 15, wherein the computer-executable instructions further cause the computing platform to facilitate:
scheduling a time to execute the one or more simulated social engineering attacks for the target.

19. The non-transitory computer-readable medium of claim 15, wherein the computer-executable instructions further cause the computing platform to facilitate:
analyzing at least one of applicability of the one or more simulated social engineering attacks, completeness of the one or more simulated social engineering attacks, or timing for which the one or more simulated social engineering attacks is scheduled to execute.

20. The non-transitory computer-readable medium of claim 15, wherein the computer-executable instructions further cause the computing platform to facilitate:
providing, as feedback, the execution results to an organization that the target belongs to; or
providing, as feedback, the execution results for an analysis of another one or more simulated social engineering attacks for targets within the organization.
